(19) United States
(12) Patent Application Publication
(10) Pub. No.: US 2006/0292056 A1
(43) Pub. Date: Dec. 28, 2006

(54) Apparatus and method for making nanoparticles

(75) Inventor: Mong-Tung Lin, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/442,409

(22) Filed: May 26, 2006

(30) Foreign Application Priority Data
Jun. 24, 2005 (CN) 200510035535.3

(51) Int. Cl. C01F 5/24; B32B 27/04

(52) U.S. Cl. 423/430; 423/1; 423/659; 422/150; 422/151

(57) ABSTRACT

In a method for making nanoparticles, a reaction chamber and at least two reactants are firstly provided. One of the reactants is a liquid reactant, and at least one high-pressure injector is disposed in the reaction. Secondly, the liquid reactant is atomized by the injector, and simultaneously mixes with the other reactants in the reaction chamber. Nanoparticles can be precipitated from the mixture of the reactants thereby. Finally, the nanoparticles are isolated from the mixture. The reactants can mix on the micro-scale via the atomization of the liquid reactant, which efficiently reduces the mixing scale and increase the effective contact area between the reactants. Thus the particle-size distribution of the precipitate can easily be controlled.

### TECHNICAL FIELD

The present invention relates generally to methods for making nanoparticles and, more particularly, to a method for making nanoparticles via reactive precipitation.

### BACKGROUND

Nanoparticles, one of many advanced materials in the field of nanotechnology, have tremendous potential applications in many industries.

In the past decade, significant international research efforts have been directed towards the synthesis of nanoparticles. Many methods for preparing nanoparticles have been developed and reported. The methods can be classified as physical vapor deposition, chemical vapor deposition, sol-gel processing, wet chemical techniques, microemulsion processing, sonochemical processing, supercritical chemical processing, and so forth. However, no current technique can provide a reliable, simple, and low-cost method for production of nanoparticles of a specific size. Some current methods may produce particles of a desirable size, but with high cost. Other techniques suffer from an inability to control the distribution of sizes around a desired nanoparticle size. Still other techniques require specialized equipment, long processing times, or expensive special chemicals.

One potentially attractive wet chemical technique for synthesis of nanoparticles is reactive precipitation. Typical reactive precipitation processes are often carried out by mixing reactants in a stirred tank. A reactive precipitation process consists of three main steps: mixing reactants, chemical reaction, and crystal growth. However, typical reactive precipitation process can only provide macro-scaled mixing, which may limit the size and the homogeneity of the precipitate.

What is needed, therefore, is a simple, and low cost reactive precipitation process for making nanoparticles, which can provide nanoparticles with well-controlled particle-size and particle-size distribution.

### SUMMARY

In one embodiment thereof, a method for making nanoparticles is provided. Firstly, a reaction chamber and at least two reactants are provided. One of the reactants is a liquid reactant, and at least one high-pressure injector is disposed in the reaction chamber. Secondly, the liquid reactant is atomized by the injector, and simultaneously mixes with the other reactants in the reaction chamber. Thereby, nanoparticles can be precipitated from the mixture of the reactants. Finally, the nanoparticles are isolated from the mixture.

Other advantages and novel features will become more apparent from the following detailed description of preferred embodiments when taken in conjunction with the accompanying drawings.

### BRIEF DESCRIPTION OF THE DRAWINGS

Many aspects of the method for making nanoparticles can be better understood with reference to the following drawings. The components in the drawings are not necessarily drawn to scale, the emphasis instead being placed upon clearly illustrating the principles of the method for making nanoparticles. Moreover, in the drawings, like reference numerals designate corresponding parts throughout the several views.

FIG. 1 is a flow chart of a method for making nanoparticles in accordance with the present invention;

FIG. 2 is a schematic view of an apparatus in accordance with a first preferred embodiment of the present invention;

FIG. 3 is a schematic view of an apparatus in accordance with a second preferred embodiment of the present invention,

FIG. 4 is a schematic view of an apparatus in accordance with a third preferred embodiment of the present invention; and

### DETAILED DESCRIPTION OF THE PREFERRED EMBODIMENTS

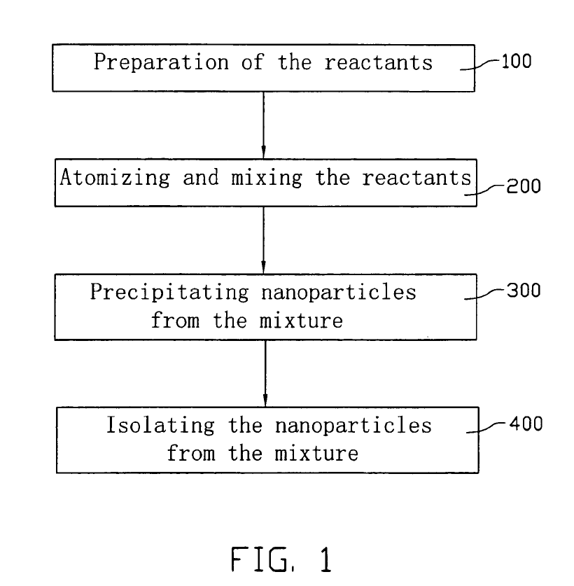

FIG. 1 shows a method for making nanoparticles, including steps 100 to 400. In step 100, several reactants, one of which is a liquid reactant, are prepared. In step 200, the liquid reactant is atomized and mixed with other reactants. In step 300, a nano-structured powder is precipitated from the mixture of the reactants. In step 400, the powder is isolated from the mixture, thus obtaining the nanoparticles.

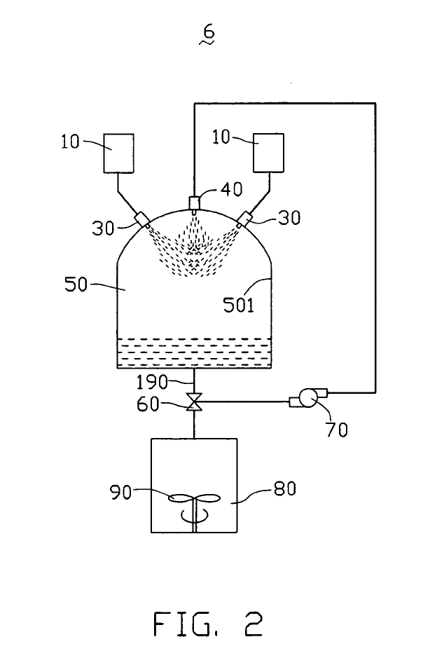

Referring to FIG. 2, an apparatus 6 for carrying out the above-mentioned method in accordance with a first preferred embodiment of the present invention, includes two solution containers 10, two injectors 30, an extra injector 40, a reaction chamber 50, a valve 60, a pump 70, a tank 80, a stirrer 90, and a plurality of pipes 190. The injectors 30 are disposed on the inside wall 501 of the reaction chamber 50. Each injector 30 is connected to a corresponding one of the solution containers 10 by the pipe 190. The tank 80 is connected to the bottom of the reaction chamber 50 by the pipe 190 and the stirrer 90 is disposed in the tank 80. The tank 80, the valve 60, the pump 70, and the extra injector 40 are connected in series by the pipes 190.

The first embodiment of the method for making nanoparticles is carried out by spray atomizing two liquid reactants to mix them together. The liquid reactants may be an aqueous sodium carbonate (Na₂CO₃) solution and an aqueous strontium nitrate (Sr(NO₃)₂) solution.

Firstly, the sodium carbonate (Na₂CO₃) solution and the strontium nitrate (Sr(NO₃)₂) solution are prepared in appropriate molarities and are then each introduced into their respective solution containers 10.

Secondly, the sodium carbonate (Na₂CO₃) solution and the strontium nitrate (Sr(NO₃)₂) solution are each atomized by their respective injectors 30, and simultaneously sprayed into the reaction chamber 50 at a rate of 2.0 liters per hour to mix together. The injectors 30 may be high-pressure swirl injectors, and the atomization pressure of the solutions may be in the range of 2˜20 Mpa (megapascals). Therefore, micro-droplets of the sodium carbonate (Na₂CO₃) solution and the strontium nitrate (Sr(NO₃)₂) solution are obtained with a diameter in the range of 20˜60 μm (micrometers), which allows the sodium carbonate (Na₂CO₃) solution and the strontium nitrate (Sr(NO₃)₂) solution to mix on a molecular scale.

After spray mixing the sodium carbonate (Na₂CO₃) solution and the strontium nitrate (Sr(NO₃)₂) solution in the reaction chamber 50, nucleation, which forms nuclei of strontium carbonate (SrCO₃) particles, occurs in the chamber 50 according to the following reaction:
Sr(NO₃)₂(l)+Na₂CO₃(l)→SrCO₃(s)+2NaNO₃(l)

Thirdly, the mixture of the sodium carbonate (Na₂CO₃) solution and the strontium nitrate (Sr(NO₃)₂) solution is transported into the tank 80 via the pipe 190, and agitated by the stirrer 90. The growth of the nuclei of strontium carbonate (SrCO₃) particles may be well controlled with the agitation of the stirrer 90. Thereby a final mixture consisting of sodium nitrate (NaNO₃), strontium carbonate (SrCO₃) particles, and a small amount of sodium carbonate (Na₂CO₃) and strontium nitrate (Sr(NO₃)₂) is obtained. The mixture of the sodium carbonate (Na₂CO₃) solution and the strontium nitrate (Sr(NO₃)₂) solution may be returned to the reaction chamber 50 via the valve 60, the pump 70 and the extra injector 40, and be reacted again to precipitate more strontium carbonate (SrCO₃).

Finally, the strontium carbonate (SrCO₃) particles are separated from the final mixture, and the strontium carbonate (SrCO₃) particles are dried to obtain an end-product nano-structured powder.

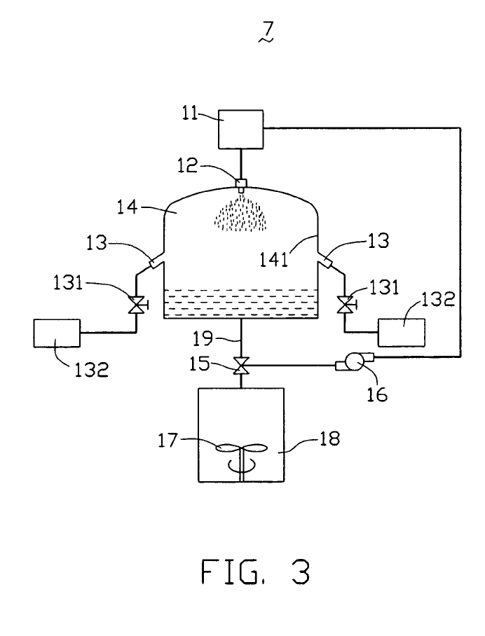

Referring to FIG. 3, an apparatus 7 for carrying out the above-mentioned method in accordance with a second preferred embodiment of the present invention, includes a solution container 11, an injector 12, two gas nozzles 13, two gas pressure controllers 131, two gas supply apparatuses, a reaction chamber 14, a valve 15, a pump 16, a stirrer 17, a tank 18 and a plurality of pipes 19. The injector 12 is disposed on the top of the inside wall 141 of the reaction chamber 14 and connected to the solution container 11 by the pipe 19. The gas nozzles 13 are disposed on the inside wall 141 of the reaction chamber 14 and connected to the gas supply apparatuses 132 via the gas pressure controllers 131 to provide gases. The tank 18 is connected to the bottom of the reaction chamber 14 by the pipe 19, and the stirrer 17 is disposed in the tank 18. The tank 18, the valve 15, the pump 16 and the solution container 11 are connected in series by the pipes 19.

The second embodiment of the method for making nanoparticles is carried out by spray atomizing a liquid reactant and mixing the liquid reactant with a gas reactant. The liquid reactant may be an aqueous sodium aluminate (NaAlO₂) solution, and the gas reactant may be carbon dioxide (CO₂).

Firstly, the aqueous sodium aluminate (NaAlO₂) solution is prepared in an appropriate molarity and introduced into the corresponding solution container 11.

Secondly, the sodium aluminate (NaAlO₂) solution is atomized by the injector 12 and sprayed into the reaction chamber 14 at a rate of 2.0 liters per hour. Simultaneously, a carbon dioxide (CO₂) gas provided by the gas supply apparatuses 132 is also injected into the reaction chamber 14 via the gas nozzles 13, and meets the atomized sodium aluminate (NaAlO₂) solution. The injector 12 may be a high-pressure swirl injector and the atomization pressure of the solution may be in the range of 2˜20 Mpa (megapascals). Therefore, micro-droplets of the sodium aluminate (NaAlO₂) solution are obtained with a diameter in the range of 20-60 μm (micrometers), which allows the sodium aluminate (NaAlO₂) solution to mix with the carbon dioxide (CO₂) on a molecular scale.

After spray mixing the sodium aluminate (NaAlO₂) solution and the carbon dioxide (CO₂) in the chamber 14, nucleation, which forms nuclei of aluminum hydroxide (Al(OH)₃) particles, occurs in the reaction chamber 14 according to the following reaction:
2NaAlO₂(l)+3H₂O(l)+CO₂(g)→Na₂CO₃(l)+2Al(OH)₃(s)

Thirdly, the mixture of the sodium aluminate (NaAlO₂) solution and the carbon dioxide (CO₂) is transported into the tank 18 via the pipe 19, and agitated by the stirrer 17. The growth of nuclei of the aluminum hydroxide (Al(OH)₃) may be well controlled with agitation of the stirrer 17. Thereby a final mixture consisting of sodium carbonate (Na₂CO₃), aluminum hydroxide (Al(OH)₃) particles, and a small amount of aluminate (NaAlO₂) that has incompletely reacted with the carbon dioxide (CO₂) is obtained. The mixture of the sodium aluminate (NaAlO₂) solution and the carbon dioxide (CO₂) may be returned into the reaction chamber 14 via the valve 15, the pump 16, the solution container 11 and the injector 12, for reaction with carbon dioxide (CO₂) again to precipitate more aluminum hydroxide (Al(OH)₃).

Finally, the aluminum hydroxide (Al(OH)₃) particles are separated from the final mixture, and the aluminum hydroxide (Al(OH)₃) particles are dried to obtain an end-product nano-structured powder.

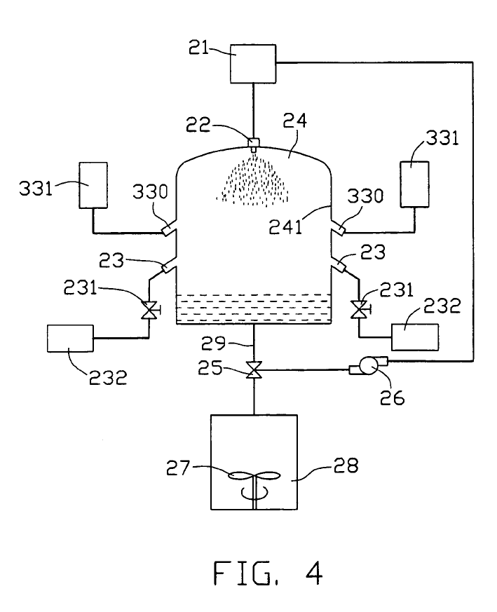

Referring to FIG. 4, an apparatus 8 for carrying out the above-mentioned method in accordance with a third preferred embodiment of the present invention, includes a solution container 21, an injector 22, two gas nozzles 23, two gas pressure controllers 231, two powder nozzles 330, two powder supply apparatuses 331, a reaction chamber 24, a valve 25, a pump 26, a stirrer 27, a tank 28 and a plurality of pipes 29. The injector 22 is disposed on the top of the inside wall 241 of the reaction chamber 24 and connected to the solution container 21 by the pipe 29. The gas nozzles 23 are disposed on the inside wall 241 of the reaction chamber 24 and connected to a corresponding one of the gas supply apparatuses 232 via the gas pressure lock 231 to provide gases. The powder nozzles 330 are disposed on the inside wall 241 of the reaction chamber 24 and connected to a corresponding one of the powder supply apparatuses 331. The tank 28 is connected to the bottom of the reaction chamber 24 by the pipe 29, and the stirrer 27 is disposed in the tank 28. The tank 28, the valve 25, the pump 26, and the solution container 21 are connected in series by the pipes 29.

The third embodiment of the method for making nanoparticles is carried out by spray atomizing a liquid reactant and mixing the liquid reactant with a gas reactant and a solid reactant. The liquid reactant, the gas reactant, and the solid reactant may be a distilled water, a carbon dioxide (CO₂) gas, and a calcium hydroxide (Ca(OH)₂) powder respectively.

Firstly, the distilled water, the carbon dioxide (CO₂), and the calcium hydroxide (Ca(OH)₂) powder are provided.

Secondly, the water is atomized by the injector 22 and sprayed into the reaction chamber 24 at a rate of 2.0 liters per hour. Simultaneously, the carbon dioxide (CO₂) gas and the calcium hydroxide (Ca(OH)₂) powder are also injected into the reaction chamber 24 via the gas nozzles 23 and the powder nozzles 30 respectively, and meet the atomized water to mix with each other. The injector 22 may be a high-pressure swirl injector and the atomization pressure of the solution may be in the range of 2˜20 Mpa (megapascals). Therefore, micro-droplets of the water can be obtained with a diameter in the range of 20-60 μm (micrometers), which allows the distilled water to mix with the calcium hydroxide (Ca(OH)₂) powder and the carbon dioxide (CO₂) on a molecular scale.

After the spray mixing of the distilled water, the calcium hydroxide (Ca(OH)₂) powder and the carbon dioxide (CO₂) in the reaction chamber 24, nucleation, which forms nuclei of calcium carbonate (CaCO₃) particles occurs in the chamber 24 according to the following reaction:
Ca(OH)₂(l)+H₂O(l)+CO₂(g)→CaCO₃(s)+2H₂O(l)

Thirdly, the mixture of the water, the calcium hydroxide (Ca(OH)₂) powder and the carbon dioxide (CO₂) is transported into the tank 28 via the pipe 29, and agitated by the stirrer 27. The growth of nuclei of the calcium carbonate (CaCO₃) may be well controlled with agitation of the stirrer 17. Thereby a final mixture consisting of water, calcium carbonate (CaCO₃) particles, and a small amount of calcium hydroxide (Ca(OH)₂) that has incompletely reacted with the carbon dioxide (CO₂) is obtained. The mixture of the distilled water, the calcium hydroxide (Ca(OH)₂) powder and the carbon dioxide (CO₂) may be returned to the reaction chamber 24 via the valve 25, the pump 26, the solution container 21 and the injector 22 in succession, and reacted with carbon dioxide (CO₂) again to precipitate more calcium carbonate (CaCO₃).

Finally, the calcium carbonate (CaCO₃) particles are separated from the final mixture, and the calcium carbonate (CaCO₃) particles are dried to obtain an end-product nano-structured powder.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

I claim:

1. A method for making nanoparticles, comprising steps of:
providing a reaction chamber with at least one high-pressure injector disposed therein and at least two reactants, one of the reactants being a liquid reactant;
atomizing the liquid reactant by the injector, and simultaneously spray mixing the liquid reactant with the other reactant in the reaction chamber, thereby precipitating nanoparticles from the mixture of the reactants; and
isolating the precipitate from the mixture.

2. The method for making nanoparticles as claimed in claim 1, further comprising the step of pumping and atomizing the mixture of the reactants into the chamber again after spray mixing the liquid reactant with the other reactant.

3. The method for making nanoparticles as claimed in claim 1, wherein the reactants include two aqueous solutions, said two aqueous solutions including sodium carbonate solution and strontium nitrate solution.

4. The method for making nanoparticles as claimed in claim 1, wherein the reactants include a gas reactant, said gas reactant including carbon dioxide.

5. The method for making nanoparticles as claimed in claim 4, wherein the liquid reactant is a sodium aluminate solution.

6. The method for making nanoparticles as claimed in claim 4, wherein the reactants include a solid reactant, the solid reactant is a calcium hydroxide powder, and the liquid reactant is distilled water.

7. The method for making nanoparticles as claimed in claim 1, wherein the injector is a high-pressure swirl injector.

8. A method for making nanoparticles, comprising steps of
atomizing a liquid reactant and simultaneously spray mixing the liquid reactant with other reactants, thereby precipitating nanoparticles from the mixture of the reactants; and
isolating the precipitate from the mixture.

9. The method for making nanoparticles as claimed in claim 8, wherein the reactants include two aqueous solutions, said two aqueous solutions including sodium carbonate solution and strontium nitrate solution.

10. The method for making nanoparticles as claimed in claim 8, wherein the reactants include a gas reactant.

11. The method for making nanoparticles as claimed in claim 10, wherein the liquid reactant is a sodium aluminate solution, the gas reactant includes carbon dioxide.

12. The method for making nanoparticles as claimed in claim 10, wherein the reactants include a solid reactant.

13. The method for making nanoparticles as claimed in claim 12, wherein the liquid reactant is distilled water, the gas reactant is carbon dioxide, and the solid reactant is a calcium hydroxide powder.

14. The method for making nanoparticles as claimed in claim 8, wherein the atomization of the liquid reactant is carried out using a high-pressure swirl injector.

15. An apparatus for making nanoparticles, comprising:
a reaction chamber;
at least two injectors mounted to the reaction chamber, the at least two injectors being configured for injecting reactants into the reaction chamber, wherein at least one of the reactants is a liquid reactant and one of the injectors is configured for atomizing the liquid reactant; and
a tank for collecting a mixture of the reactants, the tank being in flow communication with the reaction chamber.

16. The apparatus for making nanoparticles as claimed in claim 15, wherein the apparatus includes a valve, a pump, and an extra injector; the valve, the pump, and the extra injector being connected in series using a plurality of pipes.

17. The apparatus for making nanoparticles as claimed in claim 15, wherein the apparatus includes at least one container, the container being connected to the injector by a pipe.

18. The apparatus for making nanoparticles as claimed in claim 15, wherein the apparatus includes at least one gas nozzle and one gas supply apparatus, the gas nozzle is disposed on the inside wall of the reaction chamber and connected to the gas supply apparatus.

19. The apparatus for making nanoparticles as claimed in claim 15, wherein the apparatus includes at least one powder nozzle and one powder supply apparatus, the powder nozzle is disposed on the inside wall of the reaction chamber and connected to the powder supply apparatus.

20. The apparatus for making nanoparticles as claimed in claim 15, wherein a stirrer is disposed in the tank for agitating the mixture of the reactants.
